(19) United States
(12) Patent Application Publication
(10) Pub. No.: US 2010/0071068 A1
(43) Pub. Date: Mar. 18, 2010

(54) METHOD AND COMMUNICATION SYSTEM FOR THE COMPUTER-AIDED DETECTION AND IDENTIFICATION OF COPYRIGHTED CONTENTS

(75) Inventors: Thomas Bauschert, Munchen (DE); Gero Base, Munchen (DE); Michael Finkenzeller, Munchen (DE); Martin Winter, Rosenheim (DE)

Correspondence Address: K&L Gates LLP, P.O. BOX 1135, CHICAGO, IL, 60690, US

(73) Assignee: Nokia Siemens Networks GmbH & Co. KG, Munchen (DE)

(21) Appl. No.: 12/282,460

(22) PCT Filed: Mar. 8, 2007
(86) PCT No.: PCT/EP2007/052161

§ 371 Date: Mar. 5, 2009

(30) Foreign Application Priority Data
Mar. 10, 2006 (DE) 10 2006 011 294.6

(51) Int. Cl. G06F 21/00

(52) U.S. Cl. 726/26

(57) ABSTRACT

Disclosed is a method for the computer-aided detection and identification of copyrighted contents that are exchanged between at least two computers in a communication network, especially in peer-to-peer networks. Said method comprises the following steps: —first data packets that arc specified according to an execute command and are analyzed regarding at least one first criterion are fed to a first computer (PAT), first and second parameters being determined from the data packets meeting the at least one first criterion; —the first computer (PMT) determines the first data packets encompassing the second parameter from all first data packets that are fed to the first computer (PAT) and transmits said data packets to a second computer (FP); —a third computer (CRAW) sends at least one inquiry message for detecting data with copyrighted contents to the communication network, said third computer (CRAW) receives reply messages in reaction to the at least one inquiry message and requests second data packets meeting at least one second criterion from the communication network and analyzes the same, third and fourth parameters being determined from the data packets meeting the at least one second criterion; —the third computer (CRAW) determines the second data packets encompassing the fourth parameter from all second data packets that are fed to the third computer (CRAW) and transmits said data packets to the second computer (FP); —the first computer (PAT) transmits the first parameters to the third computer (CRAW) in order for said first parameters to be used in the second criteria; and—the computer (CRAW) transmits the third parameters to the second computer (PAT) in order for said third parameters to be used in the first criteria.

### CLAIM FOR PRIORITY

This application is a national stage application of PCT/EP2007/052161, filed Mar. 8, 2007, which claims the benefit of priority to German Application No. 10 2006 011 294.6, filed Mar. 10, 2006, the contents of which hereby incorporated by reference.

The invention relates to a method and a communication system for the computer-aided detection and identification of copyrighted contents which are interchanged in a communication network, particularly in peer-to-peer networks, between at least two computers.

### TECHNICAL FIELD OF THE INVENTION

The spread of digital formats and compression technologies for audio and video data has greatly influenced communication networks, such as the Internet, as lines for the worldwide exchange of music, videos and films, software and other digital information. Digitization and encoding techniques mean that files contain complete songs or else films which can easily be circulated and exchanged over the Internet. The files can be loaded on to a computer using conventional browsers, usually using the Worldwide Web (www). In this context, there are specific applications, such as KaZaA, Bittorrent, eMule and others, which allow copyrighted data to be easily sought and interchanged within peer-to-peer networks. Such piracy networks mean that the originators of the contents, such as the music and film industry, suffer large losses of sales. The increasing bandwidth for transmitting data in the communication networks means that it is also becoming increasingly simple to exchange large files, such as films.

To prevent or curb the interchange of data which have copyrighted contents, various options have been demonstrated from the prior art. These essentially involve the use of two techniques which are known in specialist circles as “fingerprinting” and “watermarking technology”.

“Fingerprinting” involves ascertaining a fingerprint of a file or a data packet with audio and/or video data. In this case, the bits in a data packet are analyzed and a fingerprint, e.g. an identification character string, is calculated and compared with identification character strings stored in a database in order to establish whether the data are identical or the same.

What is known as “watermarking” involves the owner of the copyrighted contents incorporating a watermark in to the data packets of a file, said watermark describing the content and the recipient of the file. These watermarks incorporated into the files can be extracted and compared with watermarks stored in a database in order to check identity.

In principle, data which are marked by fingerprints and watermarks and interchanged in peer-to-peer networks can be detected and identified using the fingerprints and watermarks. However, since this process has a large associated time involvement, copyrighted contents are usually detected in peer-to-peer networks using keywords. The drawback of this practice is that a search for keywords produces a large number of data meeting this criterion, and only some of these data relate to contents interchanged illegitimately in peer-to-peer networks.

The media contents available in peer-to-peer networks or file sharing services, which are to be understood to mean audio and/or video contents, are usually provided with an explicit identifier which a “peer-to-peer client computer” can use to load the desired content. The explicit identifier allows the multiplicity of data packets which describes the entire media content to be loaded by various peer-to-peer hosts.

Copyrighted contents (embodied in the form of a file which can be transmitted as a multiplicity of data packets in a communication network) in peer-to-peer networks can be located on different layers of the communication network. Thus, by way of example, this can be done by analyzing a data packet, including header and useful data. Alternatively, the detection can take place exclusively on the basis of the analysis of the useful data, for example by searching for the fingerprints or watermarks described above. Alternatively, the search can be performed using the aforementioned keywords or other contents which are provided by the peer-to-peer network independently.

To be able to curb the exchange of copyrighted contents in peer-to-peer networks, different mechanisms are known. Thus, by way of example, it is possible for data packets to be blocked or for the bandwidth of a peer-to-peer subscriber computer (host and/or client) to be restricted. Peer-to-peer data packets can be redirected or buffer-stored (to attain a time delay). It is likewise known practice to enrich the files interchanged in a peer-to-peer network with “dummy data” in order to cause a file loaded using a peer-to-peer file sharing service to be corrupted with the recipient, i.e. to cause its content to be impaired.

### SUMMARY OF THE INVENTION

The present invention to specifies a method and a communication system for the computer-aided detection and identification of copyrighted contents which prevent or at least complicate the interchange of files in peer-to-peer file sharing services.

In one embodiment of the invention, there is a method for the computer-aided detection and identification of copyrighted contents which are interchanged in a communication network, particularly in peer-to-peer networks, between at least two computers involves the following steps being performed: a first computer is supplied with first data packets which are specified on the basis of an execution specification and are analyzed with respect to at least one first criterion, wherein the data packets meeting the at least one first criterion are taken and first and second parameters are ascertained. The first computer takes all the first data packets supplied to it and ascertains those first data packets which comprise the second parameter and transmits these data packets to a second computer. A third computer sends at least one request message for detecting data with copyrighted contents to the communication network, wherein the third computer, in response to the at least one request message, receives response messages and requests second data packets meeting at least one second criterion from the communication network and analyzes them, wherein the data packets meeting the at least one second criterion are taken and third and fourth parameters are ascertained. The third computer takes all the second data packets supplied to it and ascertains those second data packets which comprise the fourth parameter and transmits these data packets to the second computer. The first computer transmits the first parameters to the third computer for use in the second criteria. The third computer transmits the third parameters to the second computer for use in the first criteria.

The use of two computers, the first and third computers, for detecting copyrighted contents allows different kinds of filtering of relevant data packets to be performed. The respective findings obtained in this context are interchanged between the first and third computers, so that their search becomes ever more target-oriented as time progresses. This means that it is possible to detect copyrighted contents in a very short time. The data packets considered to be relevant are supplied to a second computer for more accurate analysis, this computer being able to decide very reliably whether or not the filtered data packets are data packets with copyrighted contents.

The first computer analyzes the first data packets supplied to it with respect to at least one first criterion, the first computer essentially checking whether the first data packet(s) supplied to it is/are what is known as a request message. If this is the case, the first computer ascertains first and second parameters, wherein the first parameters are, by way of example, keywords and the second parameters are peer-to-peer meta data, such as hash keys, verified keywords (i.e. keywords which identify peer-to-peer data with a high level of probability or even certainty) or content-based data. In the same way, the third computer analyzes the second data packets supplied to it with respect to a second criterion. The third computer essentially checks whether the results delivered to it for a request message can be associated with peer-to-peer file sharing services. If this is the case, the third computer ascertains third and fourth parameters, wherein the third parameters are, by way of example, keywords and the second parameters are peer-to-peer meta data, particularly hash keys. The alternate provision of the first and fourth parameters produces a self-learning mechanism which allows copyrighted data to be detected and identified in a very short time. Furthermore, it is possible to detect such a large volume of data having data packets with copyrighted contents within a short space of time in order to prove that a copyright is actually being infringed.

In one embodiment, the first data packets comprising the second parameter and the second data packets comprising the fourth parameter are brought together for further analysis in a data aggregate if the second and fourth parameters match. Which of the second and fourth parameters result in the data being forwarded to the second computer can be selected using a self-learning method, for example. To analyze whether data packets have copyrighted contents, a volume of data is formed which comprises both first and second data packets which have been ascertained by the first computer and the third computer. To be able to perform target-oriented evaluation, first and second data packets for which the second and fourth parameters, e.g. a keyword or preferably a hash key, match are respectively brought together for further processing in a data aggregate. This makes it a simple matter to check whether a particular copyrighted content is being interchanged as part of the peer-to-peer file sharing services or is being downloaded by a subscriber to the peer-to-peer file sharing services.

Subsequently, at least one of the data packets in each of the data aggregates is subjected to fingerprint analysis by taking the at least one of the data packets in each of the data aggregates and ascertaining an identification character string and comparing it with reference identification character strings. As already mentioned by way of introduction, fingerprint analysis in specialist circles involves the at least one data packet being examined for a particular bit string. The bit string, referred to as a fingerprint, is compared with reference identification character strings. If there is a match, it can be assumed that the data packet comprises copyrighted content. Preferably, the analysis involves each of the data packets in each of the data aggregates being subjected to fingerprint analysis. On the basis of this, it is possible to distinguish with a high level of reliability, for example, whether a song or a film is being interchanged illegally or a legally loadable trailer is being interchanged using the peer-to-peer file sharing service. This distinction is important to the question of whether and what means are used to prevent the impermissible interchange of such data.

In another embodiment, the reference identification character strings are provided by the originator(s) of the protected contents.

In one embodiment, if the identification character strings in a data aggregate match then the second and fourth parameters are transmitted to a fourth computer which can use the second and fourth parameters to influence data packets in the communication network which have the second and fourth parameters. The influencing is also known in specialist circles by the term “policing”.

The influencing of data packets in the communication network which have the second and fourth parameters may comprise one or more of the following steps:
the data packets are blocked,
the data packets are diverted to a different computer than the destination computer indicated in the data packet,
the data packets are rejected,
the data packets are altered.

In another embodiment, if the identification character strings in a data aggregate match then the second and fourth parameters and also the data aggregate are transmitted to a fifth computer which can use these data to perform watermark analysis. The watermark analysis is the “watermarking technology” mentioned at the outset, which can be used not only to check the data packets to determine whether they involve copyrighted data material but also to check who is the recipient of the data packet(s). This practice is intended particularly to allow impermissible data interchange to be prosecuted.

In another embodiment, the first and third parameters are read from a database, wherein the data held in the database are provided by an organization managing the fifth computer. By way of example, the organization managing the fifth computer may be the owner or originator of the copyrighted content. In particular, the first and the third parameters comprise keywords which characterize and identify the copyrighted content. In addition, the first and the third parameters may also be complemented by contents which are ascertained by the first and third computers in the course of the analysis of the data packets, however.

In another embodiment, a filter computer analyzes the data packets transmitted in a first communication network and supplies the data packets meeting the execution specification as first data packets to the first computer for further processing.

By way of example, the filter computer may be a network access node computer or an aggregation point node computer. The task of the filter computer is to analyze the data packets transmitted in a first communication network to determine whether the data packet is a “peer-to-peer data packet”. This analysis can take place in a wide variety of ways. Analysis is possible which considers the entire data packet, that is to say both header and useful data. However, the analysis can also relate exclusively to the analysis of the header data or the useful data. Finally, analysis using a known context is also possible. The way in which the data packets meeting the first execution specification are ascertained is arbitrary, in principle.

In still another embodiment of the invention, a computer program product can be loaded directly into the internal memory of a digital computer and comprises software code sections which are used to execute the steps based on one of the preceding embodiments when the product is running on a computer.

In still another embodiment of the invention, there is a communication system for the computer-aided detection and identification of copyrighted contents which are interchanged in a communication network, particularly in peer-to-peer networks, between at least two computers comprises a first, a second and a third computer. The first computer, which can be supplied with first data packets specified on the basis of an execution specification, is designed:
to analyze the first data packets with respect to at least one first criterion;
to take the data packets meeting the at least one first criterion and to ascertain first and second parameters;
to take all the first data packets supplied to it and to ascertain those first data packets which comprise the second parameter and to transmit these data packets to a second computer;
to transmit the first parameters to the third computer for use in the second criteria.

The third computer is designed
to send at least one request message for detecting data with copyrighted contents to the communication network and, in response to the at least one request message, to receive response messages;
to request second data packets meeting at least one second criterion from the communication network and to analyze them, and to take the data packets meeting the at least one second criterion and to ascertain third and fourth parameters
to take all the second data packets supplied to it and to ascertain those second data packets which comprise the fourth parameter and to transmit these data packets to the second computer;
to transmit the third parameters to the second computer for use in the first criteria.

The communication system according to the invention has the same associated advantages as have been explained above in connection with the method according to the invention.

In one embodiment, the second computer is designed to bring together the first data packets comprising the second parameter and the second data packets comprising the fourth parameter for further analysis in a data aggregate if the second and fourth parameters match.

In another embodiment, the second computer is also designed to subject at least one of the data packets in each of the data aggregates to fingerprint analysis by taking the at least one of the data packets in each of the data aggregates and ascertaining an identification character string and comparing it with reference identification character strings.

In still another embodiment, a fourth computer is provided which, if the identification character strings in a data aggregate match, can be supplied with the second and fourth parameters, wherein the fourth computer is designed to use the second and fourth parameters to influence data packets in the communication network which have the second and fourth parameters.

In another embodiment, a fifth computer is provided which, if the identification character strings in a data aggregate match, can be supplied with the second and fourth parameters and also with the data aggregate, wherein the fifth computer is designed to use these data to perform watermark analysis.

In this case, it is advantageous if the fourth and/or the fifth computer are managed by a different provider than the communication system. In particular, the fifth computer may be provided in the sphere of influence of the rights holders of the copyrighted contents. The fourth computer, which is used to take suitable measures to prevent or complicate the interchange of the copyrighted contents, may be associated with another, third organization, for example, which is tasked by the rights holder to influence the data packets in this way.

In yet another embodiment according to the invention, the communication system also comprises a first database which comprises the first and the third parameters, wherein the data held in the database are provided by an organization which manages the fifth computer. The communication system may comprise a second database which comprises the identification character strings for the fingerprint analysis, wherein the data held in the database are provided by an organization which manages the fifth computer. The data which the first and second databases contain form the basis for the detection and identification of copyrighted data or data packets. Particularly the parameters held therein allow a target-oriented and therefore time-efficient search for such contents.

In addition, at least one filter computer is provided which is designed to analyze the data packets transmitted in a first communication network and to supply the data packets meeting the execution specification as first data packets to the first computer for further processing.

As already stated above, the task of the filter computer is to filter out of the data packets supplied to it those data packets which are associated with peer-to-peer file sharing services. Expediently, the at least one filter computer is arranged at a network access node and/or an aggregation node in the first communication network. Arranging the filter computer on such network nodes has the advantage that a large portion of the data packets transmitted via the first communication network is routed through these network nodes.

### BRIEF DESCRIPTION OF THE DRAWINGS

The invention is explained in more detail below with reference to the figures, in which:

FIG. 1 shows a communication system according to the invention for the computer-aided detection and identification of copyrighted contents.

### DETAILED DESCRIPTION OF THE INVENTION

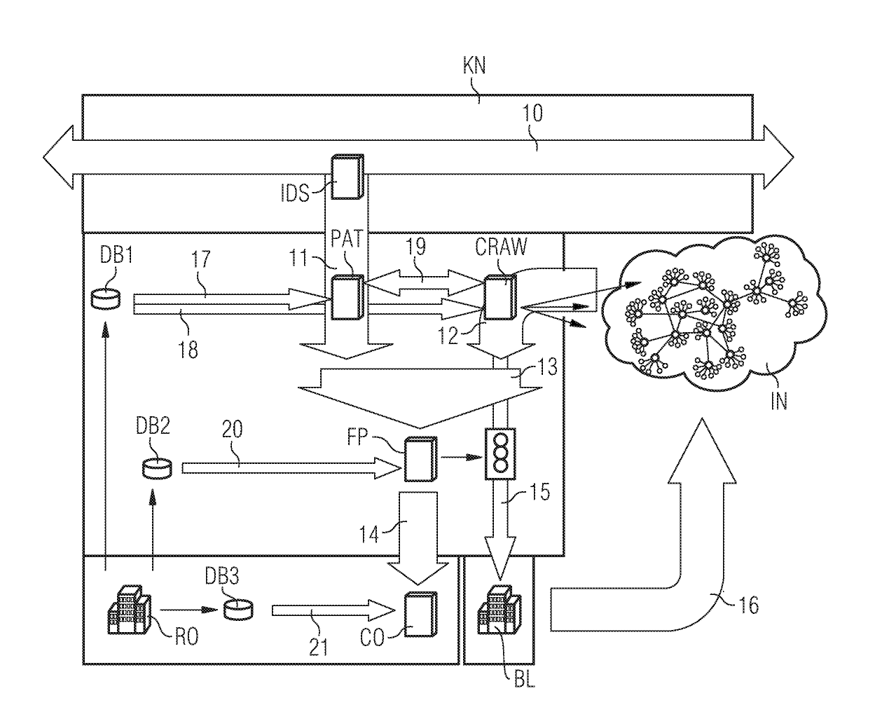

In FIG. 1, IN denotes a communication network, such as the Internet. The communication network IN may have a multiplicity of communication networks which are managed by respective providers. The communication network IN hosts peer-to-peer file sharing services, with a multiplicity of users. Examples of such peer-to-peer file sharing services are KaZaA, Bittorent, eMule and many others. These peer-to-peer file sharing services are used to exchange contents stored in digital form, such as songs and films, between the individual members of the peer-to-peer file sharing services. In this case, the data available in digitized form often comprise copyrighted content.

The communication network denoted by KN is one of the multiplicity of communication networks on the Internet (communication network IN) which are managed by various providers. Reference symbol 10 identifies a data stream which is transmitted by the communication network KN and which is routed through a network node access computer IDS. The computer IDS could also be arranged in an aggregation node in the communication network KN. The computer IDS is designed to analyze each data packet in the data stream 10. In this case, the analysis takes place such that the computer IDS draws a distinction between data packets which can be associated with peer-to-peer file sharing services and those which cannot. Those data packets which do not have a peer-to-peer context are forwarded to the desired destination node by the computer IDS without further action. Those data packets which do have a peer-to-peer context are filtered out and supplied to a computer PAT as a data stream 11, however. Contrary to the drawing and the description which follows, there may be a plurality of computers IDS provided, e.g. on each network gateway node.

The analysis of whether or not a data packet has a peer-to-peer context can be performed in any way, in principle. An association with a peer-to-peer file sharing service can be made using the evaluation of the header data, for example. Thus, data packets interchanged within the context of peer-to-peer file sharing services have, by way of example, specific codes in the header data which can be recognized by the computer IDS. However, recognition is also possible on the basis of analysis of the useful data portion of a data packet. As part of the analysis of whether or not a data packet has a peer-to-peer context, it is also possible to consider a complete data packet, i.e. both the header and the useful data. This is particularly appropriate when searching for hash keys and keywords within the data packets, which is done using signatures. This involves searching for a particular byte pattern, as is the case with virus scanners, which are part of the media contents. Another option is to search for particular traffic profiles, i.e. for particular patterns in the data packets interchange. By analyzing which computer interchanges how much data with which other computer within which space of time, it is possible to establish which computers are partners in file sharing.

To achieve good filter efficiency for the computer IDS, it is expedient if the computer is regularly updated with new signatures and data patterns identifying peer-to-peer data packets.

The task of the computer PAT, which is supplied with data packets with the data stream 11 by the computer IDS, is to analyze the protocol semantics. To this end, the computer PAT has information from the protocol semantics from at least the most popular peer-to-peer networks. The task performed by the computer PAT is to take the data packets and identify data packets which contain a search request to a peer-to-peer file sharing network in order to extract keywords and meta data, such as hash keys (HK) or content descriptions, therefrom. To perform this task, the computer PAT can already make use of the search for keywords or other parameters which are held in a database DB1. The parameters contained in the database DB1 are made available to the computer PAT as a data stream 17.

The contents of the database DB1 are provided by the rights holder of the copyrighted contents. Said rights holder is identified by the reference symbols RO.

The task to be performed by the computer PAT is of great importance with regard to the efficiency of the present communication system. It should be borne in mind that the loading of a content loaded using peer-to-peer file sharing services is completed within a particular time. In this space of time, the process of detecting and verifying (whether the detected contents infringe a copyright) and also possibly the influencing of the loading of the data stream must have been performed. In view of the ever greater available bandwidths for a download, large files can be loaded in ever shorter times. In practice, the typical download time for a new and sought-after media content from peer-to-peer networks may be several hours or even days on account of the limited upload resources and the substantial download requests. This circumstance is exploited within the context of the present invention.

The task of the computer PAT is essentially to take the data packets supplied to it and ascertain parameters which can be used for a targeted search for peer-to-peer contents.

A third computer CRAW is provided in order to perform search requests and loading requests for a plurality of peer-to-peer networks in parallel. To this end, the search terms are made available to it by the database DB1 and the computer PAT. This is illustrated by the arrows identified by the reference symbols 18 and 19. For the analysis of the data (reference symbol 12) downloaded from the peer-to-peer file sharing services, the computer CRAW is able to extract hash keys. Hash keys are used in peer-to-peer file sharing services usually to explicitly identify a particular content. In other words, this means that every media content, be it a song or a film, has an explicit hash key. The hash key is used by the clients of the peer-to-peer file sharing services in order to load a desired media content.

The hash keys detected by the computer CRAW are therefore used to load data packets with one or more hash keys from the communication network IN. In addition, the hash keys are also made available to the computer PAT by the computer CRAW (reference symbol 19) so that the computer PAT can locate data packets with the appropriate hash keys in target-oriented fashion. The data packets loaded by the computers PAT and CRAW are supplied to a computer FP (reference symbol 14). The alternate interchange of keywords and hash keys between the computers PAT and CRAW significantly speeds up the search for data packets with a peer-to-peer context. It is useful for the computer PAT to load data packets which have a particular hash key because the arrangement of the computer IDS on a network access node for the network KN means that a considerable data stream 10 is routed through the computer IDS. The probability of a large number of data packets with a peer-to-peer context and possibly the desired hash keys therefore also being routed through is therefore high.

The computer FP subjects the data packets supplied by the computers PAT and CRAW to accurate analysis. For this purpose, the computer FP forms a respective volume of data with data packets having identical hash keys. Each of the data packets is provided with a fingerprint which can be located by the computer FP. A database DB2, which is fed via the rights holder RO, provides the computer FP with reference fingerprints or reference identification character strings. By comparing the reference identification character strings with the character strings identified from the data packets, the computer FP is able to establish whether or not data packets with copyrighted content are involved. In particular, the computer FP is able to distinguish illegally exchanged media contents from trailers, which can be interchanged legally, for example. This is possible because the computer FP is provided with a comparatively large volume of data for analysis, with preferably every data packet in the volume of data being subjected to fingerprint analysis.

If the computer FP has established that the filtered data packets are copyrighted and illegally interchanged data content, the computer FP transmits keywords, hash keys and the data aggregate to a computer CO (reference symbol 14) and also transmits the keywords and hash keys to a computer BL (reference symbol 15).

The computer CO is preferably in the sphere of influence of the rights holder. On the basis of data stored in a database DB3, the rights holder is able to subject the volume of data to watermark analysis. For this purpose, the data stored in the database are transmitted to the computer CO (reference symbol 21). Using the watermark, the rights holder RO is also able to ascertain that data packet which has supplied the data to the communication network. This involves a subscriber in the peer-to-peer network who has downloaded the copyrighted content illegally. The rights holder RO is therefore rendered able to locate the peer-to-peer user and possibly to initiate further steps against him.

The computer BL is preferably with a third operator, e.g. a service provider, which is independent of the operator of the communication system according to the invention and of the rights holder. The operator of the computer BL is therefore able to influence the data packets interchanged on the Internet, for example by supplying data packets having an arbitrary content and the same hash key to the Internet, so that a meaningless data stream arrives for a recipient of a downloaded data content (reference symbol 16). In principle, the data stream can be influenced arbitrarily and, by way of example, in combination with an Internet service provider. Thus, data packets having a particular hash key could be rejected or altered. In addition, the sources of the data packets could be blocked or their bandwidth restricted.

The arrangement of the databases DB1 and DB2 and the provision of the keywords and fingerprints stored therein have the advantage that copyrighted content can be analyzed and identified using the communication system according to the invention. In this case, the databases DB1 and DB2 can be managed by a provider which is not identical to the rights holder RO. Secondly, the rights holder RO is not compelled to provide the original data of the content to be protected, which means that the provider cannot itself be the source for a peer-to-peer file sharing network.

The communication system according to the invention has a series of advantages which come from the analysis of data on various layers. The invention combines tracking solutions on various layers with tracking performed externally (by the computer IDS). The data interchange between a plurality of tracking computers is based on a self-learning mechanism.

The communication system according to the invention operates within the network of an Internet service provider and of a network provider. This allows direct access to data which are interchanged between users. The invention combines different levels of specialized filtering operations and redirection operations in order to increase overall efficiency. In this case, existing IDS systems (Intrusion Detection System) and protocol analyzers can be used. This allows a critical volume of contents to be collected for further analysis within a relatively short time. This is done on the basis of the loading of data from what is known as a crawler component and a packet filter. Another advantage is that the invention does not cause additional network traffic. A fundamental aspect in this case is the self-learning effect as a result of the interchange of keywords and associated hash keys between a packet filter and a crawler component. The self-learning mechanism may be supported by artificial intelligence. The invention allows reliable identification of impermissibly interchanged contents, in comparison with the blind blocking of peer-to-peer file sharing. The solution proposed is therefore not vulnerable to legal attacks from users of peer-to-peer file sharing services.

1. A method for the computer-aided detection and identification of copyrighted contents which are interchanged in a communication network between at least two computers:
supplying a first computer with first data packets which are specified based on an execution specification and are analyzed with respect to at least one first criterion, wherein the data packets meeting the at least one first criterion are taken and first and second parameters are ascertained;
using the first data packets supplied to the first computer ascertaining the first data packets which comprise the second parameter and transmitting the data packets to a second computer;
sending, via a third computer, at least one request message for detecting data with copyrighted contents to the communication network, wherein the third computer, in response to the at least one request message, receives response messages and requests second data packets meeting at least one second criterion from the communication network and analyzes them, wherein the data packets meeting the at least one second criterion are taken and third and fourth parameters are ascertained;
using the second data packets supplied to the third computer and ascertaining the second data packets which comprise the fourth parameter and transmits the data packets to the second computer;
transmitting, via the first computer, the first parameters to the third computer for use in the second criteria; and
transmitting, via the third computer, the third parameters to the second computer for use in the first criteria.

2. The method as claimed in claim 1,
wherein
the first data packets comprising the second parameter and the second data packets comprising the fourth parameter are brought together for further analysis in a data aggregate if the second and fourth parameters match.

3. The method as claimed in claim 2,
wherein
at least one of the data packets in each of the data aggregates is subjected to fingerprint analysis by taking the at least one of the data packets in each of the data aggregates and ascertaining an identification character string and comparing it with reference identification character strings.

4. The method as claimed in claim 3,
wherein
each of the data packets in each of the data aggregates is subjected to fingerprint analysis.

5. The method as claimed in claim 3,
wherein
the reference identification character strings are provided by the originator(s) of the protected contents.

6. The method as claimed in claim 3, wherein
if the identification character strings in a data aggregate match then the second and fourth parameters are transmitted to a fourth computer which can use the second and fourth parameters to influence data packets in the communication network which have the second and fourth parameters.

7. The method as claimed in claim 6,
wherein
the influencing of data packets in the communication network which have the second and fourth parameters comprises at least one of the following:
the data packets are blocked,
the data packets are diverted to a different computer than the destination computer indicated in the data packet,
the data packets are rejected, and
the data packets are altered.

8. The method as claimed in claim 3, wherein
if the identification character strings in a data aggregate match then the second and fourth parameters and also the data aggregate are transmitted to a fifth computer which can use these data to perform watermark analysis.

9. The method as claimed in claim 1, wherein
the first and third parameters are read from a database, wherein the data held in the database are provided by an organization managing the fifth computer.

10. The method as claimed in claim 1, wherein
a filter computer analyzes the data packets transmitted in a first communication network and supplies the data packets meeting the execution specification as first data packets to the first computer for further processing.

11. The method as claimed in claim 10,
wherein
the execution specification is met if the data packet is a peer-to-peer data packet.

12. A computer program product loaded into a memory of a digital computer and having software code sections which are executable when the product is running on a computer, comprising:
supplying a first computer with first data packets which are specified based on an execution specification and are analyzed with respect to at least one first criterion, wherein the data packets meeting the at least one first criterion are taken and first and second parameters are ascertained;
using the first data packets supplied to the first computer and ascertaining the first data packets which comprise the second parameter and transmitting the data packets to a second computer;
sending, via a third computer, at least one request message for detecting data with copyrighted contents to the communication network, wherein the third computer, in response to the at least one request message, receives response messages and requests second data packets meeting at least one second criterion from the communication network and analyzes them, wherein the data packets meeting the at least one second criterion are taken and third and fourth parameters are ascertained;
using the second data packets supplied to the third computer and ascertaining the second data packets which comprise the fourth parameter and transmits the data packets to the second computer;
transmitting, via the first computer, the first parameters to the third computer for use in the second criteria; and
transmitting, via the third computer, the third parameters to the second computer for use in the first criteria.

13. A communication system for computer-aided detection and identification of copyrighted contents which are interchanged in a communication network between at least two computers, comprising a first, a second and a third computer, wherein
the first computer, supplied with first data packets based on an execution specification, is configured to
analyze the first data packets with respect to at least one first criterion;
take the data packets meeting the at least one first criterion and to ascertain first and second parameters;
take the first data packets supplied to it and to ascertain the first data packets which comprise the second parameter and to transmit the data packets to a second computer;
transmit the first parameters to the third computer for use in the second criteria;
the third computer is configured to
send at least one request message for detecting data with copyrighted contents to the communication network and, in response to the at least one request message, to receive response messages;
request second data packets meeting at least one second criterion from the communication network and to analyze them, and to take the data packets meeting the at least one second criterion and to ascertain third and fourth parameters;
take the second data packets supplied to it and to ascertain the second data packets which comprise the fourth parameter and to transmit the data packets to the second computer;
to transmit the third parameters to the second computer for use in the first criteria.

14. The communication system as claimed in claim 13,
wherein
the second computer is designed to bring together the first data packets comprising the second parameter and the second data packets comprising the fourth parameter for further analysis in a data aggregate if the second and fourth parameters match.

15. The communication system as claimed in claim 14,
wherein
the second computer is designed to subject at least one of the data packets in each of the data aggregates to fingerprint analysis by taking the at least one of the data packets in each of the data aggregates and ascertaining an identification character string and comparing it with reference identification character strings.

16. The communication system as claimed in claim 15,
further comprising
a fourth computer which, if the identification character strings in a data aggregate match, can be supplied with the second and fourth parameters, wherein the fourth computer is designed to use the second and fourth parameters to influence data packets in the communication network which have the second and fourth parameters.

17. The communication system as claimed in claim 15,
further comprising
a fifth computer which, if the identification character strings in a data aggregate match, can be supplied with the second and fourth parameters and with the data aggregate, wherein the fifth computer is designed to use the data to perform watermark analysis.

18. The communication system as claimed in claim 16,
wherein
the fourth and/or the fifth computer are managed by a different provider than the communication system.

19. The communication system as claimed in,
claim 13,
further comprising a first database which comprises the first and the third parameters, wherein the data held in the database are provided by an organization which manages the fifth computer.

20. The communication system as claimed in
claim 13, further comprising
a second database which comprises the identification character strings for the fingerprint analysis, wherein the data held in the database are provided by an organization which manages the fifth computer.

21. The communication system as claimed
claim 13, wherein
at least one filter computer is provided which is designed to analyze the data packets transmitted in a first communication network and to supply the data packets meeting the execution specification as first data packets to the first computer for further processing.

22. The communication system as claimed in claim 21,
wherein
the at least one filter computer is arranged at a network access node and/or an aggregation node in the first communication network.

23. The communication system as claimed in claim 21,
wherein
the at least one filter computer is designed to recognize peer-to-peer data packets.
